(19) United States
(12) Patent Application Publication
(10) Pub. No.: US 2025/0093477 A1
(43) Pub. Date: Mar. 20, 2025

(54) LIDAR DETECTION METHOD, COMPUTER STORAGE MEDIUM, AND LIDAR

(71) Applicant: HESAI TECHNOLOGY CO., LTD., Shanghai (CN)

(72) Inventors: Jianxiong ZHU, Shanghai (CN); Shaoqing XIANG, Shanghai (CN)

(73) Assignee: HESAI TECHNOLOGY CO., LTD., Shanghai (CN)

(21) Appl. No.: 18/903,457

(22) Filed: Oct. 1, 2024

Related U.S. Application Data
(63) Continuation of application No. PCT/CN2022/119953, filed on Sep. 20, 2022.

(30) Foreign Application Priority Data
Apr. 2, 2022 (CN) 202210351674.0

(51) Int. Cl. G01S 7/487; G01S 7/481; G01S 7/484; G01S 17/10

(52) U.S. Cl. CPC G01S 7/487; G01S 7/4814; G01S 7/484; G01S 17/10

(57) ABSTRACT

A method for LiDAR detection includes: controlling a laser of a LIDAR to emit a detection beam at a first time point; applying a first working voltage to a detector of the LiDAR from the first time point to a second time point, wherein a magnitude of the first working voltage is less than or equal to a breakdown voltage of the detector; applying a second working voltage to the detector after the second time point, wherein a magnitude of the second working voltage is greater than the breakdown voltage of the detector; determining an electrical crosstalk signal of the detector; and determining an echo signal of the detection beam reflected by an object based on a detection signal received by the detector after the second time point and the electrical crosstalk signal.

### CROSS-REFERENCE TO RELATED APPLICATIONS

This application is a continuation application of, and claims benefit of, copending International Patent Application No. PCT/CN2022/119953, filed on Sep. 20, 2022, which claims priority to Chinese Patent Application No. 202210351674.0, filed on Apr. 2, 2022; the contents of all of which are incorporated herein by reference in their entireties.

### TECHNICAL FIELD

This disclosure relates to the field of photoelectric detection and, in particular, to methods for LiDAR detection, computer storage medium, and LiDARs.

### BACKGROUND

As a widely used ranging sensor, a LiDAR has advantages of long detection distance, high resolution, strong resistance to active interference, small size, light weight, or the like. The LiDAR can be widely used in intelligent robots, drones, unmanned vehicles, or other fields.

Optical paths of the LiDAR can be classified into coaxial optical paths and paraxial optical paths. For the LiDAR of coaxial optical paths, an emission optical path and a receiving optical path of the LiDAR at least partially overlap. The overlap of the emission optical path and the receiving optical path can cause some of the emitted laser to enter directly into the receiving optical path of the LiDAR and be received by a detector, rather than being emitted outside the LiDAR for object detection. In such a case, the saturation of the detector can be caused for a period of time. The detector does not respond to laser reflected by an object during a saturation period of time. The LiDAR, thus, can be caused to have a short-range blind zone. However, the short-range blind zone is typically expected to be as small as possible.

### SUMMARY

This disclosure provides a method for LiDAR detection. The method includes the following steps. A laser of a LiDAR is controlled to emit a detection beam at a first time point. A first working voltage is applied to a detector of a LiDAR from the first time point to a second time point. A magnitude of the first working voltage is less than or equal to a breakdown voltage of the detector. A second working voltage is applied to the detector after the second time point. A magnitude of the second working voltage is greater than the breakdown voltage of the detector. An electrical crosstalk signal of the detector is determined. An echo signal of the detection beam reflected by an object is determined based on a detection signal received by the detector after the second time point and the electrical crosstalk signal.

In some embodiments of this disclosure, determining the electrical crosstalk signal of the detector includes the following steps. A third working voltage is applied to the detector. A magnitude of the third working voltage is less than or equal to the magnitude of the first working voltage. The first working voltage is applied to the detector. An output signal of the detector is determined when the third working voltage is changed to the first working voltage. The output signal is determined as the electrical crosstalk signal.

In some embodiments of this disclosure, determining the electrical crosstalk signal of the detector includes the following steps. A current ambient temperature is determined. The breakdown voltage, the first working voltage, the second working voltage, and the third working voltage are updated based on the current ambient temperature. The updated third working voltage is applied to the detector. The updated first working voltage is applied to the detector. An updated output signal of the detector is determined when the updated third working voltage is changed to the updated first working voltage. The updated output signal is determined as the electrical crosstalk signal.

In some embodiments of this disclosure, the LiDAR includes an emission optical path and a receiving optical path. The emission optical path and the receiving optical path at least partially overlap. The electrical crosstalk signal is determined when the detector is not set to receive the detection signal.

In some embodiments of this disclosure, determining the electrical crosstalk signal of the detector includes the following steps. The breakdown voltage of the detector is determined at a first temperature. The first working voltage and a third working voltage are determined based on the breakdown voltage. A magnitude of the third working voltage is less than or equal to the magnitude of the first working voltage. The third working voltage is applied to the detector at the first temperature. The first working voltage is applied to the detector. A first output signal of the detector is stored when the third working voltage is changed to the first working voltage. The first output signal of the detector at the first temperature is stored as a first electrical crosstalk signal. The breakdown voltage of the detector at a second temperature is updated. The first working voltage and the third working voltage are updated based on the updated breakdown voltage. The updated third working voltage is applied to the detector at the second temperature. The updated first working voltage is applied to the detector and a second output signal of the detector is stored when the updated third working voltage is changed to the updated first working voltage. The second output signal is stored as a second electrical crosstalk signal of the detector at the second temperature.

In some embodiments of this disclosure, the method further includes the following steps. A stored electrical crosstalk signal of a plurality of stored electrical crosstalk signals is determined to be an electrical crosstalk signal. The plurality of the stored electrical crosstalk signals include the first electrical crosstalk signal and the second electrical crosstalk signal. The stored electrical crosstalk signal corresponds to a current ambient temperature. In some embodiments of this disclosure, determining the electrical crosstalk signal of the detector includes the following steps. The electrical crosstalk signal of the detector is determined based on one of the plurality of the stored electrical crosstalk signals.

In some embodiments of this disclosure, a difference value between the third working voltage and the first working voltage is equal to a difference value between the first working voltage and the second working voltage.

In some embodiments of this disclosure, the magnitude of the first working voltage is equal to the breakdown voltage of the detector.

In some embodiments of this disclosure, determining the echo signal of the detection beam reflected by the object based on the detection signal received by the detector after the second time point and the electrical crosstalk signal includes as follows. The echo signal is determined by subtracting the electrical crosstalk signal from the detection signal.

In some embodiments of this disclosure, the detector is configured to operate in a Geiger mode.

This disclosure further discloses a non-transitory computer-readable storage medium. The non-transitory computer-readable storage medium stores instructions. When the instructions are executed by a processor, the processor is caused to perform the method as described above.

This disclosure further discloses a LiDAR. The LiDAR includes a laser configured to emit a detection beam. The LiDAR includes a detector configured to receive an optical signal. The LiDAR includes a controller connected to the laser and the detector. The controller is configured to control the laser to emit a detection beam at a first time point. The controller is configured to apply a first working voltage to the detector from the first time point to a second time point. A magnitude of the first working voltage is less than or equal to a breakdown voltage of the detector. The controller is configured to apply a second working voltage to the detector after the second time point. A magnitude of the second working voltage is greater than the breakdown voltage of the detector. The controller is configured to determine an electrical crosstalk signal of the detector. The controller is configured to determine an echo signal of the detection beam reflected by an object based on a detection signal received by the corresponding detector after the second time point and the electrical crosstalk signal.

In some embodiments of this disclosure, the controller is further configured to execute the following steps. The controller is configured to apply a third working voltage to the detector. A magnitude of the third working voltage is less than or equal to the magnitude of the first working voltage. The controller is configured to apply the first working voltage to the detector to determine an output signal of the detector when the third working voltage changes to the first working voltage. The controller is configured to determine the output signal as the electrical crosstalk signal.

In some embodiments of this disclosure, the controller is further configured to determine a current ambient temperature. The controller is further configured to update the breakdown voltage, the first working voltage, the second working voltage, and the third working voltage based on the current ambient temperature. The updated third working voltage is applied to the detector. The updated first working voltage is applied to the detector. An updated output signal of the detector is determined when the updated third working voltage is changed to the updated first working voltage. The updated output signal is determined as the electrical crosstalk signal.

In some embodiments of this disclosure, the LiDAR includes an emission optical path and a receiving optical path. The emission optical path and the receiving optical path at least partially overlap. The controller is configured to determine the electrical crosstalk signal when the detector is not set to receive the detection signal.

In some embodiments of this disclosure, the LiDAR further includes a storage medium. The storage medium is configured to store electrical crosstalk signals correspond to multiple temperatures. The controller is further configured to determine an electrical crosstalk signal corresponding to the current ambient temperature among the stored electrical crosstalk signals based on the current ambient temperature.

In some embodiments of this disclosure, a difference value between the third working voltage and the first working voltage is equal to a difference value between the first working voltage and the second working voltage.

In some embodiments of this disclosure, the magnitude of the first working voltage is equal to the breakdown voltage of the detector.

In some embodiments of this disclosure, the controller is further configured to subtract the electrical crosstalk signal from the detection signal to determine the echo signal.

In some embodiments of this disclosure, the detector operates in a Geiger mode.

In this disclosure, by controlling the bias voltage of a detector, the bias voltage of the detector can be made less than the operating voltage of the detector for a short period of time after the laser is emitted. Then, the bias voltage of the detector can be changed to the working voltage to perform object detection. In such a case, the detector does not respond to laser that enters directly into the detector, rather than being emitted outside of the LiDAR. This can reduce the long duration of non-ranging period due to the saturation of detectors. The time when the detector cannot perform ranging can be shortened. The short-range blind zone of a LiDAR can be reduced. Furthermore, an electrical crosstalk signal caused by a bias voltage variation can be determined without the interference by the external ambient light. Then an echo signal can be determined based on a detection signal and the electrical crosstalk signal. The accuracy of the echo signal can be improved without reducing a signal-to-noise ratio. Based on the method and the LiDAR of this disclosure, the short-range blind zone can be reduced, and the accuracy of the echo signal can be improved as well.

### BRIEF DESCRIPTION OF THE DRAWINGS

Drawings are a part of this disclosure and are used to provide a further understanding of this disclosure. Schematic embodiments of this disclosure and description thereof are used for a purpose of explaining this disclosure and do not constitute an undue limitation of this disclosure.

FIG. 1 shows a schematic diagram of a LiDAR whose transceiver system has a coaxial optical path, according to some embodiments of this disclosure.

FIG. 2 shows a flowchart of a first method for LiDAR detection, according to some embodiments of this disclosure.

FIG. 3 shows a schematic diagram of a LiDAR, according to some embodiments of this disclosure.

FIG. 4 shows a schematic diagram of an emission signal and a receiving signal, according to some embodiments of this disclosure.

FIG. 5 shows a schematic diagram of a detector circuit in a light-receiver apparatus, according to some embodiments of this disclosure.

FIG. 6a shows a schematic diagram of a signal of an electrical crosstalk signal, according to some embodiments of this disclosure.

FIG. 6b shows a schematic diagram of a signal of an electrical crosstalk signal superimposed with an echo signal, according to some embodiments of this disclosure.

FIG. 6c shows a schematic diagram of a signal after an electrical crosstalk signal is removed, according to some embodiments of this disclosure.

FIG. 7 shows a flowchart of a method for the detection of an electrical crosstalk signal, according to some embodiments of this disclosure.

FIG. 8 shows a flowchart of an example for the detection of an electrical crosstalk signal at different ambient temperatures, according to some embodiments of this disclosure.

FIG. 9a shows a schematic diagram of an example for a method, according to some embodiments of this disclosure.

FIG. 9b shows a schematic diagram of an example for a detector circuit, according to some embodiments of this disclosure.

FIG. 9c shows a schematic diagram of an example for a detector circuit, according to some embodiments of this disclosure.

### DETAILED DESCRIPTION

In the following, merely some example embodiments are briefly described. As can be understood by those skilled in the art, described embodiments can be modified in various ways without departing from the spirit or scope of this disclosure. Accordingly, drawings and description are by example rather than limitation.

In the description of this disclosure, it should be understood that an orientation or positional relationship indicated by terms such as “center,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” is based on the orientation or positional relationship shown in drawings, and are merely for convenience of describing this disclosure and simplifying the description, rather than indicate or imply that an apparatus or an element referred to must have a specific orientation, be configured and operated in a specific orientation, and therefore cannot be understood as a limitation on this disclosure. In addition, terms “first” and “second” are merely for descriptive purposes and cannot be understood as indicating or implying relative importance, or implicitly indicating the number of indicated technical features. Therefore, features limited with “first” and “second” can explicitly or implicitly include one or more features. In the description of this disclosure, “multiple” means two or more, unless otherwise specifically limited. The terms “or” and “and/or” of this disclosure describe an association relationship between associated objects and represent a non-exclusive inclusion. For example, each of “A and/or B” and “A or B” can include: only “A” exists, only “B” exists, and “A” and “B” both exist, where “A” and “B” can be singular or plural. For another example, each of “A, B, and/or C” and “A, B, or C” can include: only “A” exists, only “B” exists, only “C” exists, “A” and “B” both exist, “A” and “C” both exist, “B” and “C” both exist, and “A”, “B”, and “C” all exist, where “A,” “B,” and “C” can be singular or plural. In addition, the symbol “/” herein represents that the associated objects before and after the character are in an “or” relationship. In this disclosure, the term “at least one of A or B” has a meaning equivalent to “A or B” as described above. The term “at least one of A, B, or C” has a meaning equivalent to “A, B, or C” as described above.

In the description of this disclosure, it should also be noted that unless otherwise specified and limited, terms “installing,” “coupling,” and “connecting” should be understood in a broad sense. For example, it can be a fixed connection, a detachable connection, or an integral connection; it can be a mechanical connection, an electrical connection, or a communication connection; and it can be a direct connection or an indirectly connection through an intermediate medium, or it can be an internal linkage within two elements or an interaction relationship between two elements. For those ordinary skilled in the art, meanings of the above terms in this disclosure can be understood based on a situation.

In this disclosure, unless otherwise specified and limited, a first feature being located “above” or “below” a second feature can involve direct contact between the first feature and second feature or can involve that the first feature and second feature are not in direct contact with each other but in contact through additional features between them. Moreover, the first feature being located “over,” “above,” or “on” the second feature can involve that the first feature is directly above or obliquely above the second feature, or merely represent that the level of the first feature is higher than that of the second feature. The first feature being located “under,” “below,” or “beneath” the second feature can involve that the first feature is directly below or obliquely below the second feature, or merely represent that the level of the first feature is lower than that of the second feature.

The following disclosure provides some different embodiments or examples for implementing different structures of this disclosure. To simplify this disclosure, components and settings of specific examples are described below. They are some examples and are not intended to limit this disclosure. In addition, at least one of reference numerals or reference letters can be repeated in different examples in this disclosure. This repetition is for a purpose of simplicity and clarity and does not in itself represent a relationship between embodiments or settings discussed. In addition, this disclosure provides examples of various processes and materials, but at least one of application of other processes or use of other materials can be conceived by those ordinary skilled in the art.

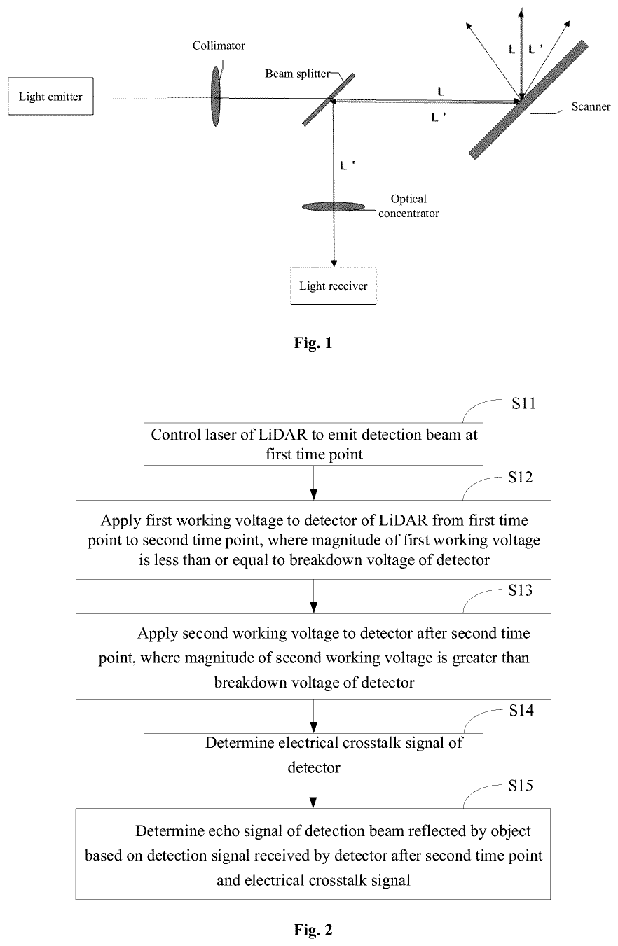

FIG. 1 shows a schematic diagram of a LiDAR whose transceiver system has a coaxial optical path, according to some embodiments of this disclosure. The LiDAR includes a light emitter and a light receiver. A detection beam L emitted by the light emitter passes through a collimator and a beam splitter. A scanner then reflects the detection beam L to the outside of the LiDAR. An echo L′ reflected by an object is received by the light receiver after passing through the scanner, the beam splitter, and an optical concentrator. The LiDAR can detect object distance and reflectivity in an environment by emitting the detection beam and receiving an echo beam reflected by the object. In some embodiments, the beam splitter can partially overlap the emission optical path and the receiving optical path of the LiDAR to reduce the size of the LiDAR. For example, the beam splitter can be a semi-transparent and semi-reflective mirror, or a pinhole mirror. However, of the overlap between the emission optical path and the receiving optical path can cause the following problems. A portion of the detection beam L is emitted to the outside of the LiDAR for ranging. The other portion of the detection beam L can directly enter a detector in the light receiver (e.g., the detector can be a single photon avalanche photodiode such as a SPAD or a SiPM). The detection beam directly entering the detector can make the detector saturated. While saturated, the detector does not respond to the reflected laser for a period. The responsiveness of the detector to a laser gradually recovers after a small period of time (i.e., a dead time of the SPAD or the SiPM). For example, the small period of time can be 20 ns. A distance calculation related to the 20 ns can be performed based on the time of flight method, 20 ns×3×10⁸ m/s÷2=3 m. The calculation indicates that an object within a range of 3 meters may not be detected during the saturation period. Such undetectable distance causes short-range blind zone of the LiDAR. The short-range blind zone is typically expected to be as small as possible (e.g., within a range of 1 m).

FIG. 2 shows a flowchart of an example for a method for detection, according to some embodiments of this disclosure. In some embodiments, the method for detection can be performed by a LiDAR, a controller, a controlling chip, or the like. With reference to FIG. 2, the method for detection includes the following steps. At S11, a laser of a LiDAR is controlled to emit a detection beam at a first time point. At S12, a first working voltage is applied to a detector of a LiDAR from the first time point to a second time point. A magnitude of the first working voltage is less than or equal to a breakdown voltage of the detector. At S13, a second working voltage is applied to the detector after the second time point. A magnitude of the second working voltage is greater than the breakdown voltage of the detector. At S14, an electrical crosstalk signal of the detector is determined. At S15, an echo signal of the detection beam reflected by an object is determined based on a detection signal received by the detector after the second time point and the electrical crosstalk signal. In this disclosure, the electrical crosstalk signal caused by a bias voltage variation can also be determined. Then an echo signal can be determined based on the detection signal and the electrical crosstalk signal. In such a case, the short-range blind zone of the LiDAR can be reduced without lowering a signal-to-noise ratio.

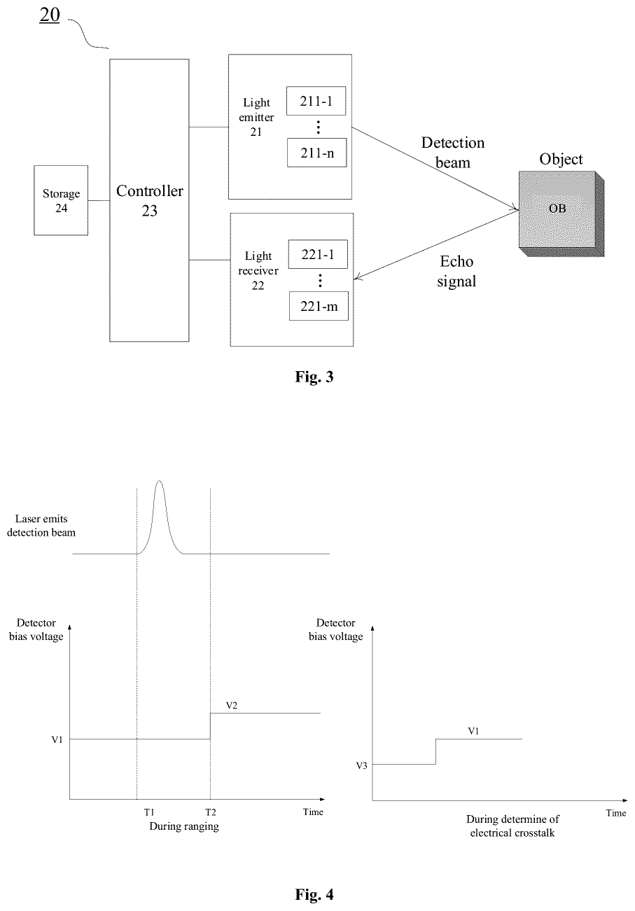

FIG. 3 shows a schematic diagram of an example LiDAR, according to some embodiments of this disclosure. A LiDAR 20 includes a light emitter 21 and a light receiver 22. The light emitter 21 includes at least one laser 211. The light receiver 22 includes at least one detector 221. For one of the lasers 211 and its corresponding detector 221, the method for detection can include steps S11 to S15 as described below.

At S11, a laser 211 of a LiDAR is controlled to emit a detection beam at a first time point.

At S12, a first working voltage is applied to a detector 221 of a LiDAR from the first time point to a second time point. A magnitude of the first working voltage is less than or equal to a breakdown voltage of the detector 221.

FIG. 4 shows an example of a detection signal and an example of a receiving signal, according to some embodiments of this disclosure. With reference to FIG. 4, the laser 211 emits the detection beam at a first time point T1. The detection beam can include a single pulse or multiple pulses. This disclosure does not limit the number of pulses. A case with a single pulse is shown in FIG. 4.

Still with reference to FIG. 4, for example, when a positive voltage is applied to the detector 221 (e.g., the cathode of the detector 221 can be close to a voltage-applying terminal, and the anode of the detector 221 can be close to a grounding terminal), a first working voltage V1 can be applied to the detector 221 from the first time point T1 to the second time point T2. The first working voltage V1 can be less than or equal to a breakdown voltage (“VBR”). For another example, when a negative voltage is applied to the detector 221 (e.g., the anode of the detector 221 can be close to the voltage-applying terminal, and the cathode of the detector can be close to the grounding terminal), a first working voltage (−V1) can be less than or equal to the VBR. For example, the magnitude of the first working voltage can be less than or equal to the VBR of the detector 221. An avalanche photodiode (e.g., SPAD or SiPM) does not respond to photons to generate electrical signals based on a working principle thereof when bias voltages of the avalanche photodiode are less than or equal to the VBR thereof. In this case, the avalanche photodiode cannot work.

For example, a positive voltage can be applied to the detector 221. When the laser 211 emits detection beam, the detector 221 is operated at the first working voltage V1 less than or equal to the VBR. In such a case, the detector 221 cannot respond to the light from the first time point T1 to the second time point T2. By doing so, even if some of the detection beam enters directly into the detector 221, the detector 221 does not saturate.

At S13, a second working voltage V2 is applied to the detector 221 after the second time point T2. A magnitude of the second working voltage V2 is greater than the breakdown voltage of the detector 221.

Still with reference to FIG. 4, when a positive voltage is applied to the detector 221 (e.g., the cathode of the detector 221 can be close to the voltage-applying terminal, and the anode of the detector 221 can be close to the grounding terminal), the second working voltage V2 can be applied to the detector 221 after the second time point T2. The second working voltage V2 can be greater than the VBR. At this time, the detector 221 can enter a normal working state (e.g., a ranging mode) and start to respond to the light reflected by the object. When a negative voltage is applied to the detector 221 (e.g., the anode of the detector 221 can be close to the voltage-applying terminal, and the cathode of the detector can be close to the grounding terminal), the magnitude of the second working voltage V2 can be greater than the VBR of the detector 221.

At S14, an electrical crosstalk signal of the detector 221 is determined.

For example, a positive voltage can be applied to the detector 221. The detector 221 can work at the second working voltage V2 greater than the VBR. In such a case, the detector 221 can enter the ranging mode after the second time point T2 and start to respond to the light reflected by the object to output an electrical signal. The electrical signal can be an echo signal. In some embodiments, the detector 221 can output the echo signal. In some embodiments, due to presence of a parasitic capacitor in a circuit, the electrical crosstalk signal can be generated when the voltage is increased from V1 to V2. The detection signal provided by the detector can include the echo signal and the electrical crosstalk signal. In some embodiments, the electrical crosstalk signal can be determined based on predetermination (e.g., a determined electrical crosstalk stored in memory) or detection, and a determined electrical crosstalk can be determined.

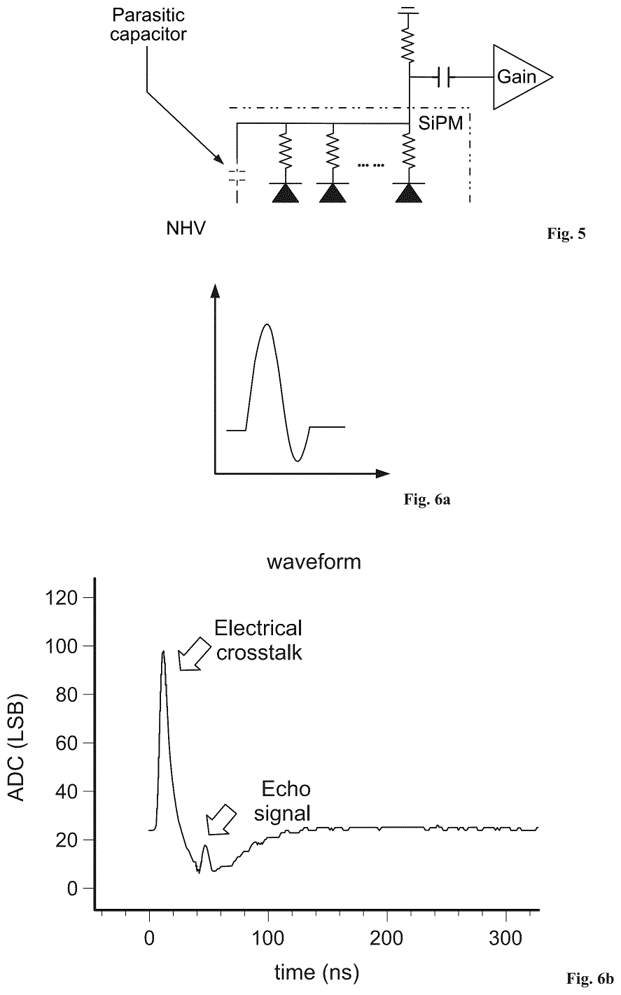

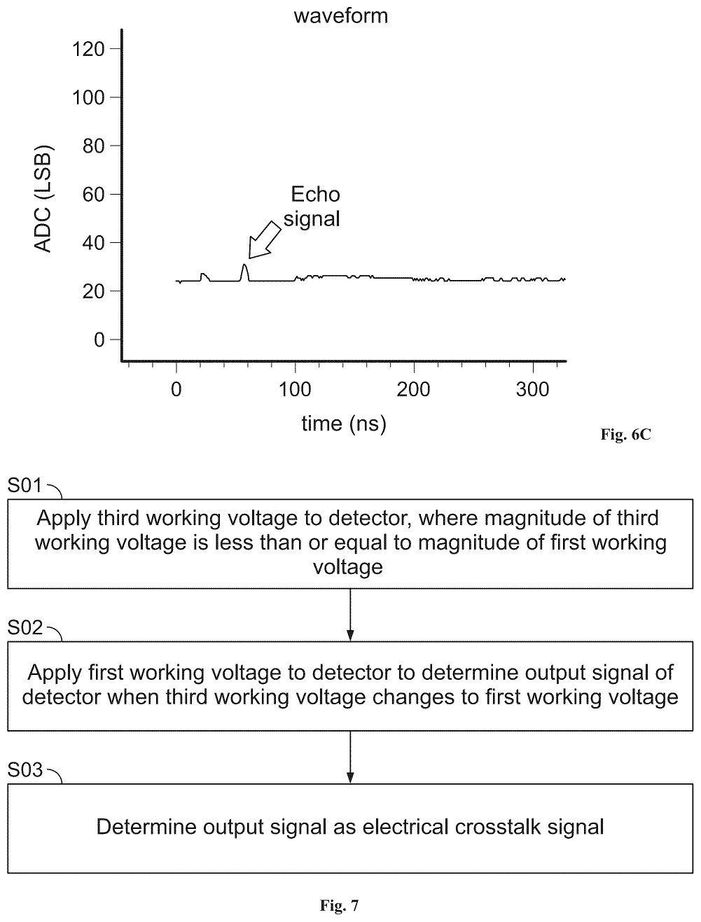

FIG. 5 shows a schematic diagram of an example for a detector circuit in a light-receiver apparatus, according to some embodiments of this disclosure. The detector circuit can include the detectors 221. The detector 221 can include a SiPM. After a bias voltage is applied to the detector 221, the detector 221 can respond to light and outputs the detection signal. The detection signal can be outputted to a follow-up circuit after being amplified by an amplifier. Due to the parasitic capacitor in the detector circuit, in a process of increasing the bias voltage of the detector 221 from the first working voltage V1 to the second working voltage V2, the detection signal outputted by the detector 221 can include the electrical crosstalk signal. FIG. 6a shows a schematic diagram of an example for a signal of an electrical crosstalk signal, according to some embodiments of this disclosure. FIG. 6b shows a schematic diagram of an electrical crosstalk signal superimposed with an echo signal, according to some embodiments of this disclosure. With reference to FIG. 6a, the electrical crosstalk signal is a signal with a high instantaneous peak value. With reference to FIG. 6b, an echo signal from an object at close range can be superimposed with the electrical crosstalk signal to form a superimposed signal. Compared to the electrical crosstalk signal, the echo signal can be very small. The signal formed by superposition of the two signals can easily cause problems such as misjudgment and inaccurate reflectivity calculation. In such a case, it is beneficial to remove an impact caused by the electrical crosstalk signal. How to determine the electrical crosstalk signal of the detector 221 can be introduced in detail below.

At S15, an echo signal of the detection beam reflected by an object is determined based on the detection signal received by the detector 221 after the second time point T2 and the electrical crosstalk signal.

For example, a positive voltage can be applied to the detector 221. With reference to FIG. 4 and FIG. 6b, the detector 221 can enter the ranging mode after the bias voltage of the detector 221 is increased from the first working voltage V1 to the second working voltage V2. The collected detection signal can be a superimposed signal formed by the echo signal and the electrical crosstalk signal. FIG. 6c shows a schematic diagram of an echo signal after an electrical crosstalk signal is removed, according to some embodiments of this disclosure. With reference to FIG. 6c, the electrical crosstalk signal in the superimposed signal can be removed based on the determined electrical crosstalk signal.

In some embodiments, at S15, the echo signal can be determined by subtracting the electrical crosstalk signal from the detection signal received by the detector 221.

During the ranging, the detection signal outputted by the detector 221 can include the echo signal and the electrical crosstalk signal. From the first time point T1 to the second time point T2, the detector 221 cannot respond to a portion of the detection beam. In such a case, the saturation cannot be caused. By rationally determining T1 and T2, the short-range blind zone can be greatly reduced. For example, the time difference between T1 and T2 can be set to 5 ns (i.e., T2−T1=5 ns). In such a case, a short-blind zone range of the LiDAR can be reduced to 0.75 m (5 ns*×3×10⁸ m/s÷2=0.75 m).

The detection method is introduced through step S11 to S15. A real echo signal can be determined based on the obtained detection signal and the electrical crosstalk signal. In some embodiments, the short-range blind zone of the LiDAR can be reduced.

FIG. 7 shows a flowchart of a method for the detection of an electrical crosstalk signal, according to some embodiments of this disclosure. With reference to FIG. 7, the example method for detection of an electrical crosstalk signal can include S01 to S03.

At S01, a third working voltage is applied to the detector 221. A magnitude of the third working voltage is less than or equal to the magnitude of the first working voltage.

Still with reference to FIG. 4, when the positive voltage is applied to the detector 221, a third working voltage V3 can be applied to the detector 221. The third working voltage V3 can be less than the first working voltage V1. When the negative voltage is applied to the detector 221, the magnitude of the third working voltage V3 can be less than the magnitude of the first working voltage V1. The magnitude of the first working voltage V1 can be less than or equal to the VBR, and the magnitude of the third working voltage V3 can be also less than the VBR. In such a case, the detector 221 does not respond to an external optical signal when it works at the third working voltage V3. Thus, the electrical crosstalk signal determined by follow-up steps includes little or no noise caused by ambient light. By doing so, it can ensure that the signal-to-noise ratio of the received echo signal will not be lowered. With the presence of the ambient light noise, the detection signal received during normal ranging of the LiDAR inevitably introduces the ambient light noise. If the electrical crosstalk signal is determined under the bias voltage greater than the VBR, the ambient light noise can be also introduced. Because the ambient light noise is irregular, a phenomenon of increasing the ambient light noise can be caused during a process of subtracting the electrical crosstalk signal from the detection signal. In such a case, the signal-to-noise ratio of the received echo signal can be lowered. Furthermore, the remote measurement performance of the LiDAR can be affected. In some embodiments. the first working voltage V1 and the third working voltage V3 can be less than or equal to the VBR. In such a case, the detector does not respond to ambient light. The ambient light noise will not be introduced during a process of determining the electrical crosstalk. The signal-to-noise ratio of the echo signal received by subtracting the electrical crosstalk signal from the detection signal will not be lowered.

At S02, the first working voltage is applied to the detector 221 to determine an output signal of the detector 221 when the third working voltage is changed to the first working voltage.

The magnitude of the electrical crosstalk signal outputted by the detector 221 can be affected by two factors. One can be a variation range for the bias voltage of the detector, and the other can be the magnitude of the bias voltage. When measuring a distance or determining an electrical signal, the electrical crosstalk signals output by the detector 221 are not exactly the same, but very similar. When the two electrical crosstalk signals are very similar to each other, the electrical crosstalk signal generated during ranging can be replaced by the determined electrical crosstalk signal. For example, the electrical crosstalk signal generated when the third working voltage V3 is changed to the first working voltage V1 can be used to replace the electrical crosstalk signal generated when the first working voltage V1 is changed to the second working voltage V2. Still with reference to FIG. 4, in the ranging mode, the bias voltage of the detector 221 is increased from the first working voltage V1 to the second working voltage V2. A voltage variation range is ΔV1=V2−V1. A bias voltage median is Vm1=V1+ΔV1/2. When the electrical crosstalk signal is determined, the bias voltage of the detector 221 is increased from the third working voltage V3 to the first working voltage V1. A voltage variation range is ΔV2=V1−V3. A bias voltage median is Vm2=V1−ΔV2/2. By rationally setting the first working voltage V1 and the third working voltage V3, the bias voltage variation range ΔV1 and the bias voltage variation range ΔV2 can be close to each other and the bias voltage median Vm1 and the bias voltage median Vm2 can be close to each other. In such a case, the electrical crosstalk signals can be also similar. In some embodiments, by rationally setting the first working voltage V1 and the third working voltage V3, a difference between the electrical crosstalk signals can be within 20%. In some embodiments, a difference value between the third working voltage and the first working voltage can be equal to a difference value between the first working voltage and the second working voltage.

The electrical crosstalk signal outputted by the detector 221 can be affected by a bias voltage variation range. Still with reference to FIG. 4, when the electrical crosstalk signal is determined, the bias voltage of the detector 221 is increased from the third working voltage V3 to the first working voltage V1. The voltage variation range is ΔV2=V1−V3. In the ranging mode, the bias voltage of the detector 221 is increased from the first working voltage V1 to the second working voltage V2. The voltage variation range is ΔV1=V2−V1. When ΔV2=ΔV1, the electrical crosstalk signal generated in the ranging mode and the electrical crosstalk signal obtained when determining the electrical crosstalk signal can be similar. In such a case, the accuracy of the determined echo signal can be high when the electrical crosstalk signal is removed from the detection signal. In such a case, the ranging accuracy can be achieved without degradation.

At S03, the output signal is determined as the electrical crosstalk signal.

The electrical crosstalk signal can be determined (e.g., storing the output signal) and retrieved when S14 in the detection method is executed.

How to determine the electrical crosstalk signal is described through the steps S01 to S03. The detector can determine electrical crosstalk signals at a bias voltage at which the detector does not respond to external optical signals. By doing so, the signal-to-noise ratio of the echo signal will not be reduced. The detection signal received during normal ranging of the LiDAR inevitably introduces the ambient light noise. Because the ambient light noise is irregular, if ambient light noise is also introduced when determining the electrical crosstalk signal, a phenomenon of increasing the ambient light noise can be caused during a process of subtracting the electrical crosstalk signal from the detection signal. In such a case, the signal-to-noise ratio of the echo signal may be reduced. Therefore, the remote measurement performance of the LiDAR can be affected. In some embodiments of this disclosure, when the electrical crosstalk signal is determined, the bias voltage of the detector can be changed from the third working voltage to the first working voltage. The magnitude of the third working voltage and the magnitude of the first working voltage can be less than or equal to the breakdown voltage. By doing so, in an entire process of determining the electrical crosstalk signal, the detector 221 does not respond to the external ambient light. There is no ambient light noise introduced in the process of measuring the electrical crosstalk signal. In such a case, the signal-to-noise ratio will not be reduced after the electrical crosstalk signal is subtracted from the detection signal.

In some embodiments, the electrical crosstalk signal can be determined, by repeating the steps S01 to S03 after a predetermined time. For example, the step of determining the electrical crosstalk signal further includes as follows. The steps S01 to S03 can be repeated after a predetermined time. The determined electrical crosstalk signal can be updated (e.g., the previously determined electrical crosstalk signal can be updated.)

For example, the step of determining the electrical crosstalk signal can be executed for a predetermined time interval or every predetermined time interval. The previously determined electrical crosstalk signal can be updated by the new electrical crosstalk signal, and the new electrical crosstalk signal can be stored. Then the electrical crosstalk signal that has been determined and stored. At S14, the electrical crosstalk signal of the detector 221 can be determined based on the stored electrical crosstalk signal. For another example, the electrical crosstalk signal can also be determined and stored in advance. Then the electrical crosstalk signal that has been stored can be called at S14 when the method is performed for multiple times. In such a case, the electrical crosstalk signal can be reused to save the computing power.

In some embodiments, the step of determining the electrical crosstalk signal further includes as follows. A current ambient temperature can be determined. The VBR, the first working voltage V1, the second working voltage V2, and the third working voltage V3 can be updated based on the current ambient temperature. The steps S01 to S03 can be repeated based on the changed VBR, the changed first working voltage V1, the changed second working voltage V2 and the changed third working voltage V3. The determined electrical crosstalk signal can be updated. For example, the third working voltage can be applied to the detector. The updated first working voltage can be applied to the detector to determine an updated output signal of the detector when the updated third working voltage changes to the updated first working voltage. The updated output signal can be determined as the electrical crosstalk signal.

The magnitude of the VBR of the detector 221 is related to an ambient temperature. When the ambient temperature changes, the VBR corresponding to the detector 221 also changes. To determine a more accurate electrical crosstalk signal, the VBR can be first determined based on the current ambient temperature before the electrical crosstalk signal is determined. Then the first working voltage, second working voltage, and third working voltage can be determined based on the VBR.

In the case that the ambient temperature is constant, the electrical crosstalk signal can be measured once and stored. The electrical crosstalk signal can be reused when the method is performed subsequently. In the case that the ambient temperature changes, it is beneficial to change the first working voltage, the second working voltage, and the third working voltage based on the changed breakdown voltage VBR. The electrical crosstalk signal can be determined. The previously determined electrical crosstalk signal can be updated by the newly determined electrical crosstalk signal.

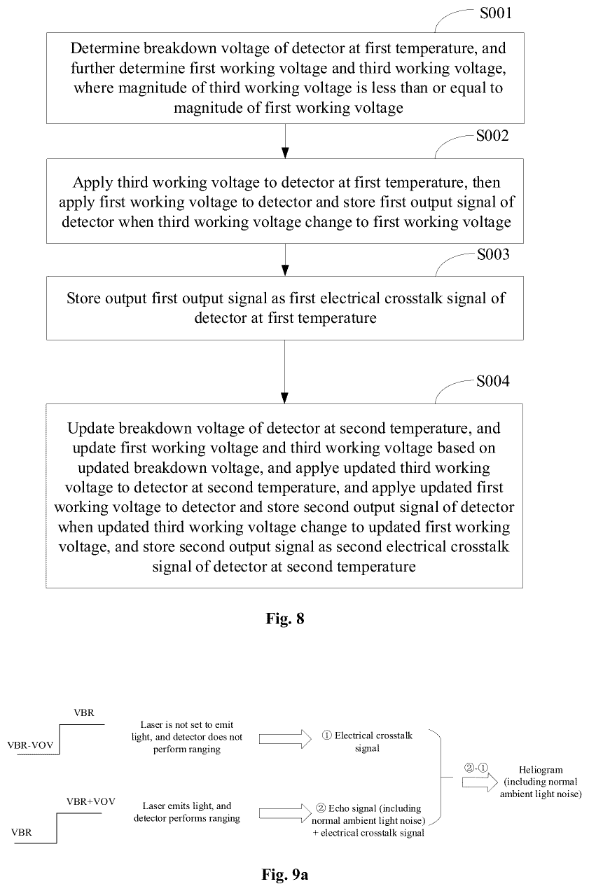

In some embodiments, the method can further include storing electrical crosstalk signals at different temperatures. FIG. 8 shows a flowchart of an example for the detection of an electrical crosstalk signal at different ambient temperatures, according to some embodiments of this disclosure. With reference to FIG. 8, the step includes the following steps. At S001, the VBR of the detector 221 is determined at a first temperature. The first working voltage and a third working voltage are determined based on the breakdown voltage. A magnitude of the third working voltage is less than or equal to the magnitude of the first working voltage. At S002, the third working voltage V3 is applied to the detector 221 at the first temperature. The third working voltage V3 is changed to the first working voltage V1. The first working voltage is applied to the detector, and a first output signal of the detector when the third working voltage changes to the working voltage is stored. At S003, the first output signal is stored as the first electrical crosstalk signal of the detector 221 at the first temperature. At S004, the temperature is changed and the steps S001 to S003 are repeated. Electrical crosstalk signals correspond to multiple temperatures are stored. For example, the breakdown voltage of the detector at a second temperature can be updated. The first working voltage and the third working voltage can be updated based on the updated breakdown voltage. The updated third working voltage can be applied to the detector at the second temperature. The updated first working voltage can be applied to the detector, and a second output signal of the detector when the updated third working voltage changes to the updated first working voltage can be stored. The second output signal can be stored as a second electrical crosstalk signal of the detector at the second temperature.

In some embodiments, the method can further include following steps. An electrical crosstalk signal can be determined as one of a plurality of stored electrical crosstalk signals. The plurality of the stored electrical crosstalk signals include the first electrical crosstalk signal and the second electrical crosstalk signal. The electrical crosstalk signal corresponds to a current ambient temperature can be stored.

A difference between the above embodiment and the previous embodiment lies in as follows. The electrical crosstalk signals at different temperatures can be determined and stored. The VBR of the detector 221 can be determined based on the current ambient temperature when the method is performed. In such a case, the detector 221 can be accurately controlled to enter the ranging mode. The corresponding electrical crosstalk signal can be retrieved based on the current ambient temperature. The electrical crosstalk signal can be removed from the detection signal. In such a case, the short-range blind zone of the LiDAR 20 can be reduced without reducing the signal-to-noise ratio of the echo signal.

In some embodiments, the LiDAR 20 includes an emission optical path and a receiving optical path. The emission optical path and the receiving optical path at least partially overlap. The electrical crosstalk signal is determined when the detector 221 is not set to receive the detection signal.

For the LiDAR of a coaxial optical path, the emission optical path and the receiving optical path at least partially overlap. The laser 211 can emit a detection beam. A large portion of the detection beam can be emitted to the outside of the LiDAR for the detection. A small portion of the energy may directly enter the detector 221. To reduce the interference of this portion of the energy as well as the external optical signal, the electrical crosstalk signal can be determined when the detector 221 is not set to receive the detection signal. The process of determining the electrical crosstalk signal can be performed at a voltage less than or equal to the VBR. The determined electrical crosstalk signal will not introduce extra interference signals or noise (e.g., ambient optical noise). Among them, the time that the detector 221 is not set to receive the detection signal means that when the LiDAR is not set to perform a ranging operation, the laser is not set to emit the laser beam in that period of time, and the detector is not set to receive the detection signal. In other word, the detector can determine electrical crosstalk signals at times outside the time window for ranging. Where the time window for ranging refers to the period of time from the start of emission of the detection beam to the time until the flight time required to reach the maximum range of the LiDAR. For example, when a LiDAR of a rotating mirror is used, a distance measurement is generally not performed when switching between multiple mirror faces of the rotating mirror. The determination of the electrical crosstalk signal can be performed when switching between multiple mirror faces of the rotating mirror. For another example, when a LiDAR of a galvanometer scanner is used, a distance measurement is generally not performed when the galvanometer scanner changes its spinning direction. The determination of the electrical crosstalk signal can be performed when the galvanometer scanner changes its spinning direction.

In some embodiments, the magnitude of the first working voltage can be equal to the magnitude of the VBR of the detector 221.

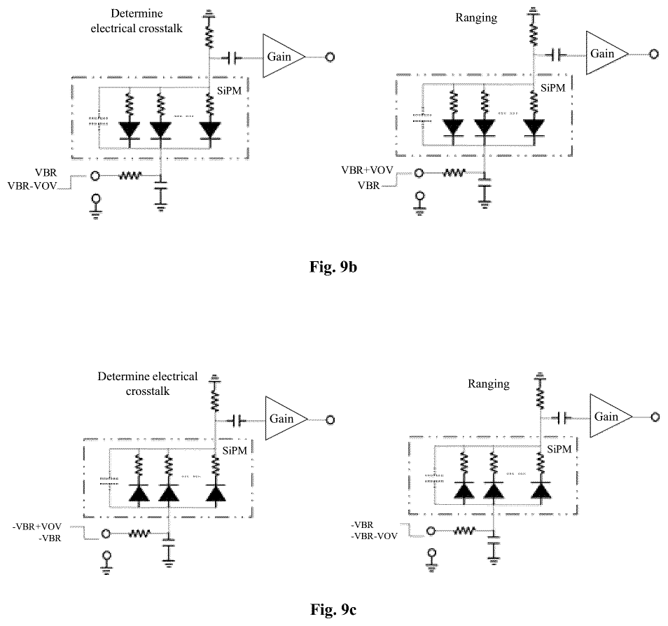

FIG. 9a shows a schematic diagram of an example for a method, according to some embodiments of this disclosure. FIG. 9b shows a schematic diagram of an example for a detector circuit according to some embodiments of this disclosure. With reference to FIG. 9a and FIG. 9b, the detector circuit can include the detector 221 formed by a SiPM or SiPMs. The positive voltage is applied to the detector 221 (e.g., the cathode of the detector 221 is close to the voltage-applying terminal, and the anode of the detector 221 is close to the grounding terminal). The VBR can be determined based on the current ambient temperature. For example, the first working voltage is V1, and V1=VBR. The second working voltage is V2, and V2=VBR+VOV. The third working voltage is V3, and V3 =VBR−VOV. When the electrical crosstalk signal is determined, a bias voltage VBR−VOV (i.e., V3) is first applied to the detector 221. Then the bias voltage of the detector 221 is increased from VBR−VOV (i.e., V3) to VBR (i.e., V1) to determine an output signal of the detector 221 when the third working voltage changes to the first working voltage. The output signal can be the electrical crosstalk signal. The bias voltage of the detector 221 is less than VBR throughout the determination process. The detector 221 does not respond to light, and the electrical crosstalk signal output by the detector 221 does not include a response to the external light signal. During the ranging, the laser 211 can emit a detection beam. A bias voltage VBR (e.g., V1) is first applied to the detector 221 and held for the period of time. The laser 211 can complete emission of the detection beam within the period of time. Then the bias voltage of the detector 221 is increased from VBR (e.g., V1) to VBR+VOV (e.g., V2). The detector 221 can receive a detection signal. The detection signal can include an electrical crosstalk signal and an echo signal of the detection beam reflected by an object. An accurate echo signal can be received by subtracting the electrical crosstalk signal from the detection signal.

FIG. 9c shows a schematic diagram of an example for a detector circuit, according to some embodiments of this disclosure. With reference to FIG. 9c, the detector circuit can include the detector 221 formed by a SiPM or SiPMs. A difference between the embodiments of FIG. 9c and the embodiments of FIG. 9b lies in as follows. A negative voltage is applied to the detector 221 (e.g., the positive electrode of the detector 221 is close to the voltage-applying terminal, and the negative electrode of the detector is close to the grounding terminal). In some embodiments, the VBR can be determined based on the current ambient temperature. For example, the first working voltage is V1, and V1=−VBR. The second working voltage is V2, and V2=−VBR−VOV. The third working voltage is V3, and V3=−VBR+VOV. Among them, VBR and VOV can be positive numbers. When an electrical crosstalk signal is determined, a bias voltage −VBR+VOV (e.g., V3) is first applied to the detector 221. Then the voltage is changed from −VBR+VOV (i.e., V3) to −VBR (e.g., V1) to determine an output signal of the detector 221 when the third working voltage is changed to the first working voltage. The output signal can be the electrical crosstalk signal. The bias voltage (e.g., a magnitude of V1 and a magnitude of V2) of the detector 221 can be less than or equal to the VBR throughout the determination process. The detector 221 does not be responsive to light, and the electrical crosstalk signal output by the detector 221 does not include a response to the external light signal. During the ranging process, the laser 211 can emit a detection beam. A voltage −VBR (e.g., V1) is first applied to the detector 221 and held for the period of time. The laser 211 can complete the emission of the detection beam within the period of time. Then the voltage is changed from −VBR (e.g., V2) to −VBR−VOV (e.g., V1). The detector 221 can receive a detection signal. The detection signal can include an electrical crosstalk signal and an echo signal of the detection beam reflected by an object. An accurate echo signal can be received by subtracting the electrical crosstalk signal from the detection signal.

In some embodiments, the detector 221 can operate in a Geiger mode.

The detector 221 can be a detector operating in a Geiger mode, such as a SPAD and a SiPM. The response of the detector 221 to the laser can be reduced to zero or the detector can hardly respond to the laser when a third working voltage or a first working voltage is applied to the detector 221. The third working voltage and the first working voltage can be less than the VBR. In such a case, the determined electrical crosstalk signal can be more accurate. In addition, by rationally determining the time that the detector cannot perform the ranging, the short-range blind zone can be reduced.

In some embodiments of this disclosure, the bias voltage of the detector 221 can be controlled to initially be the first working voltage, and then controlled to be increased from the first working voltage to the second working voltage. The magnitude of the first working voltage can be less than or equal to the breakdown voltage. The magnitude the second working voltage can be greater than the breakdown voltage. By doing so, the time that the detector 221 cannot perform the ranging can be short. The short-range blind zone of a LiDAR of a coaxial transceiver system can be reduced. The bias voltage of the detector 221 can be controlled to be increased from the third working voltage to the first working voltage. The magnitude of the third working voltage can be less than the breakdown voltage. The electrical crosstalk signal generated can be determined when the third working voltage changes to the first working voltage, and the detector 221 cannot respond to the external optical signal when the third working voltage changes to the first working voltage. The electrical crosstalk signal can be subtracted from a determined detection signal during the ranging. In such a case, the ranging accuracy can be ensured without reducing the signal-to-noise ratio of the echo signal.

This disclosure provides operation steps for the method as described in the embodiments or flowcharts. However, more or fewer operation steps can be included based on conventional or uncreative labor. A sequence of steps enumerated in the embodiments is merely a manner among many possible sequences, and does not represent the sole execution sequence. When being executed in practice, a system or device product can be executed sequentially or in parallel based on the method shown in the embodiments or flowcharts.

This disclosure further relates to a non-transitory computer-readable storage medium. The non-transitory computer-readable storage medium can store instructions. When the instructions are executed by a processor, the processor can be caused to perform the method as described.

This disclosure further relates to a LiDAR. Still with reference to FIG. 3, the LiDAR 20 includes a laser 211 (e.g., a laser 211-1, . . . , a laser 211-n). The laser 211 can emit a detection beam. The LiDAR 20 includes a detector 221 (e.g., a detector 221-1, . . . , a detector 221-m). The detector 221 can receive an optical signal. The LiDAR 20 includes a controller 23 connected with the at least one laser 211 and the at least one detector 221. A controller 23 can be connected to the laser 211 and the detector 221. The controller 23 can control the laser 211 to emit a detection beam at a first time point T1. The controller 23 can apply a first working voltage V1 to the detector 221 from the first time point T1 to a second time point T2. A magnitude of the first working voltage V1 can be less than or equal to a breakdown voltage VBR of the detector 221. The controller 23 can apply a second working voltage V2 to the detector 221 after the second time point T2. A magnitude of the second working voltage V2 can be greater than the VBR of the detector 221. The controller 23 can determine an electrical crosstalk signal of the detector 221. The controller 23 can determine an echo signal of the detection beam reflected by an object based on a detection signal received by the corresponding detector 221 after the second time point T2 and the electrical crosstalk signal.

In some embodiments, the controller 23 can further execute the following operations for determining the electrical crosstalk signal. At S01, a third working voltage V3 can be applied to the detector 221. A magnitude of the third working voltage V3 can be less than or equal to the magnitude of the first working voltage V1. At S02, the first working voltage V1 can be applied to the detector 221 to determine an output signal of the detector 221 when the third working voltage changes to the first working voltage. At S03, the output signal can be determined (e.g., by stored) as the electrical crosstalk signal.

In some embodiments, the controller 23 can further repeat the steps S01 to S03 after a predetermined time and updated the previously determined electrical crosstalk signal.

In some embodiments, the controller 23 can further determine a current ambient temperature. The controller 23 can further update the VBR, first working voltage V1, second working voltage V2, and third working voltage V3 based on the current ambient temperature. The controller 23 can further repeat the steps S01 to S03 and update the previously determined electrical crosstalk signal. For example, the third working voltage can be applied to the detector. The updated first working voltage can be applied to the detector to determine an updated output signal of the detector when the updated third working voltage is changed to the updated first working voltage. The updated output signal can be determined as the electrical crosstalk signal.

In some embodiments, the LiDAR 20 includes an emission optical path and a receiving optical path. The emission optical path and the receiving optical path can at least partially overlap. The controller 23 can execute the step of determining the electrical crosstalk signal when the detector is not set to receive the detection signal.

In some embodiments, the LiDAR 20 can further include a storage medium 24. The storage medium 24 can store electrical crosstalk signals correspond to multiple temperatures. The controller 23 can further determine an electrical crosstalk signal corresponding to the current ambient temperature from the stored electrical crosstalk signals based on the current ambient temperature.

In some embodiments, a difference value between the third working voltage V3 and the first working voltage V1 can be equal to a difference value between the first working voltage V1 and the second working voltage V2.

In some embodiments, the magnitude of the first working voltage V1 can be equal to the VBR of the detector.

In some embodiments, the controller 23 can further subtract the electrical crosstalk signal from the detection signal received by the detector 221 to determine the echo signal.

In some embodiments, the detector 221 can operate in a Geiger mode.

In this disclosure, the bias voltage of a detector 221 can be controlled. An electrical crosstalk signal can be determined without the inference from the external optical signal. Then an echo signal can be received based on the detection signal and the electrical crosstalk signal. In such a case, the accuracy of the echo signal can be ensured without reducing the signal-to-noise ratio. The time that the detector cannot perform the ranging can also be shortened. Therefore, a short-range blind zone can be reduced. In some embodiments, based on the current ambient temperature, the VBR of the detector can be changed and the corresponding electrical crosstalk signal can be retrieved. In such a case, the accuracy of the determined echo signal can be kept or improved.

It should be finally noted that the above are merely exemplary embodiments of this disclosure and are not intended to limit this disclosure. Although this disclosure has been described in detail with reference to the foregoing embodiments, those skilled in the art can still modify the technical solutions described in the foregoing embodiments or equivalently replace some of the technical features. Any modifications, equivalents, improvements, or the like, made within the spirit and principle of this disclosure should fall within the protection scope of this disclosure.

1. A method for LiDAR detection, comprising:
controlling a laser of a LIDAR to emit a detection beam at a first time point;
applying a first working voltage to a detector of the LiDAR from the first time point to a second time point, wherein a magnitude of the first working voltage is less than or equal to a breakdown voltage of the detector;
applying a second working voltage to the detector after the second time point, wherein a magnitude of the second working voltage is greater than the breakdown voltage of the detector;
determining an electrical crosstalk signal of the detector; and
determining an echo signal of the detection beam reflected by an object based on a detection signal received by the detector after the second time point and the electrical crosstalk signal.

2. The method of claim 1, wherein determining the electrical crosstalk signal of the detector comprises:
applying a third working voltage to the detector, wherein a magnitude of the third working voltage is less than or equal to the magnitude of the first working voltage;
applying the first working voltage to the detector and determining an output signal of the detector when the third working voltage is changed to the first working voltage; and
determining the output signal as the electrical crosstalk signal.

3. The method of claim 2, wherein determining the electrical crosstalk signal of the detector comprises:
determining a current ambient temperature;
updating the breakdown voltage, the first working voltage, the second working voltage, and the third working voltage based on the current ambient temperature;
applying the updated third working voltage to the detector;
applying the updated first working voltage to the detector and determining an updated output signal of the detector when the updated third working voltage is changed to the updated first working voltage; and
determining the updated output signal as the electrical crosstalk signal.

4. The method of claim 1, wherein the LIDAR comprises an emission optical path and a receiving optical path, wherein the emission optical path and the receiving optical path at least partially overlap, and wherein the electrical crosstalk signal is determined when the detector is not set to receive the detection signal.

5. The method of claim 1, wherein determining the electrical crosstalk signal of the detector comprises:
determining the breakdown voltage of the detector at a first temperature;
determining the first working voltage and a third working voltage based on the breakdown voltage, wherein a magnitude of the third working voltage is less than or equal to the magnitude of the first working voltage;
applying the third working voltage to the detector at the first temperature;
applying the first working voltage to the detector and storing a first output signal of the detector when the third working voltage is changed to the first working voltage;
storing the first output signal as a first electrical crosstalk signal of the detector at the first temperature;
updating the breakdown voltage of the detector at a second temperature;
updating the first working voltage and the third working voltage based on the updated breakdown voltage;
applying the updated third working voltage to the detector at the second temperature;
applying the updated first working voltage to the detector and storing a second output signal of the detector when the updated third working voltage is changed to the updated first working voltage; and
storing the second output signal as a second electrical crosstalk signal of the detector at the second temperature.

6. The method of claim 5, further comprising:
determining one of a plurality of stored electrical crosstalk signals as the electrical crosstalk signal, wherein the plurality of the stored electrical crosstalk signals comprise the first electrical crosstalk signal and the second electrical crosstalk signal, and the electrical crosstalk signal corresponds to a current ambient temperature.

7. The method of claim 5, wherein a difference value between the third working voltage and the first working voltage is equal to a difference value between the first working voltage and the second working voltage.

8. The method of claim 1, wherein the magnitude of the first working voltage is equal to the breakdown voltage of the detector.

9. The method of claim 1, wherein determining the echo signal of the detection beam comprises:
determining the echo signal by subtracting the electrical crosstalk signal from the detection signal.

10. The method of claim 1, wherein the detector is configured to operate in a Geiger mode.

11. A non-transitory computer-readable storage medium storing instructions that when executed by a processor, cause the processor to perform the method of claim 1.

12. A LIDAR, comprising:
a laser configured to emit a detection beam;
a detector configured to receive an optical signal; and
a controller connected to the laser and the detector, wherein the controller is configured to:
control the laser to emit the detection beam at a first time point;
apply a first working voltage to the detector from the first time point to a second time point, wherein a magnitude of the first working voltage is less than or equal to a breakdown voltage of the detector;
apply a second working voltage to the detector after the second time point, wherein a magnitude of the second working voltage is greater than the breakdown voltage of the detector;
determine an electrical crosstalk signal of the detector; and
determine an echo signal of the detection beam reflected by an object based on a detection signal received by the corresponding detector after the second time point and the electrical crosstalk signal.

13. The LiDAR of claim 12, wherein the controller is further configured to:
apply a third working voltage to the detector, wherein a magnitude of the third working voltage is less than or equal to the magnitude of the first working voltage;
apply the first working voltage to the detector to determine an output signal of the detector when the third working voltage is changed to the first working voltage; and
determine the output signal as the electrical crosstalk signal.

14. The LIDAR of claim 13, wherein the controller is further configured to:
determine a current ambient temperature;
update the breakdown voltage, the first working voltage, the second working voltage, and the third working voltage based on the current ambient temperature; and
apply the updated third working voltage to the detector;
apply the updated first working voltage to the detector and determine an updated output signal of the detector when the updated third working voltage is changed to the updated first working voltage; and
determine the updated output signal as the electrical crosstalk signal.

15. The LiDAR of claim 12, wherein the LiDAR comprises an emission optical path and a receiving optical path, wherein the emission optical path and the receiving optical path at least partially overlap, and wherein the controller is configured to determine the electrical crosstalk signal when the detector is not set to receive the detection signal.

16. The LIDAR of claim 15, further comprising a storage medium configured to store electrical crosstalk signals corresponding to a plurality of temperatures, and the controller is further configured to: determine an electrical crosstalk signal corresponding to the current ambient temperature among the stored electrical crosstalk signals based on the current ambient temperature.

17. The LiDAR of claim 13, wherein a difference value between the third working voltage and the first working voltage is equal to a difference value between the first working voltage and the second working voltage.

18. The LiDAR of claim 12, wherein the magnitude of the first working voltage is equal to the breakdown voltage of the detector.

19. The LiDAR of claim 12, wherein the controller is further configured to: subtract the electrical crosstalk signal from the detection signal to determine the echo signal.

20. The LIDAR of claim 12, wherein the detector operates in a Geiger mode.
